(19) United States
(12) Patent Application Publication
(10) Pub. No.: US 2014/0299561 A1
(43) Pub. Date: Oct. 9, 2014

(54) STORAGE SYSTEM

(71) Applicant: Penn United Technologies, Inc., Cabot, PA (US)

(72) Inventors: Mark P. Noah, Butler, PA (US); Michael Kelley, Sarver, PA (US)

(73) Assignee: Penn United Technologies, Inc., Cabot, PA (US)

(21) Appl. No.: 14/244,124

(22) Filed: Apr. 3, 2014

Related U.S. Application Data
(60) Provisional application No. 61/808,333, filed on Apr. 4, 2013.

(51) Int. Cl. A47B 46/00; F16M 13/02; A47B 43/00

(52) U.S. Cl. CPC A47B 46/00; A47B 43/003; F16M 13/022
USPC 211/116; 248/288.31

(57) ABSTRACT

A storage system is provided. The storage system includes a shelf, a number of elongated frame members and a number of support assemblies having a spherical coupling. The support assemblies are coupled to beams. The frame members extend downwardly from the support assemblies and are coupled to the shelf. The support assemblies' spherical coupling allows for the frame members to be disposed at an adjustable angle relative to the shelf. Thus, regardless of the spacing of the beams, the support assemblies are directly coupled to the beams.

### CROSS REFERENCE TO RELATED APPLICATION

This application is a claims priority to U.S. Provisional Patent Application Ser. No. 61/808,333, filed Apr. 4, 2013 entitled STORAGE SYSTEM.

### BACKGROUND OF THE INVENTION

1. Field of the Invention

The disclosed and claimed concept relates to a storage system and, more specifically, to a storage system that can be coupled to beams with other than standard spacing.

2. Background Information

Beams, studs, and posts are rigid members, along with other rigid members, disposed behind ceilings and walls. That is, a series of spaced, parallel rigid members are disposed behind interior surfaces in a building. Alternatively, in unfinished rooms, such as, but not limited to basements and garages, the beams may be exposed. Hereinafter, “beams” shall be used as a collective term for all such rigid members whether disposed generally horizontally or generally vertically. For some time it has been standard in the construction industry to space beams at regular intervals of about 16 inches or 24 inches. Generally, when a device needs to be hung from the ceiling or from a wall, it is desirable to mount the device on the beams; that is, the mounting hardware extends into the beam. Accordingly, many devices, such as but not limited to storage systems, are structured with mountings spaced at about 16 inches or 24 inches apart, or some multiple thereof, e.g. about 32 or 48 inches apart.

For example, a ceiling shelving unit may include a shelf with four upwardly extending frame members. Pairs of the frame members would be spaced about 16 inches or 24 inches apart so that two frame members could be coupled to one beam and the other two frame members could be coupled to the other beam; that is, the upper ends of the frame members include a right angle bracket with a passage therethrough. To install the shelving unit a user would pass a screw through the bracket and into the beams there above.

Some buildings, including but not limited to homes built before the standard beam spacing was generally adopted, have beams that are spaced other than about 16 inches or 24 inches apart. Thus, when installing a device with mountings having a standard spacing, the user typically couples one mounting to a beam and the other mounting to the paneling. Such an installed device is weaker, i.e. cannot support as much weight, as an installed device that is coupled to two beams.

### SUMMARY OF THE INVENTION

The disclosed and claimed concept provides for a storage system that includes a shelf, a number of elongated frame members and a number of support assemblies having a spherical coupling. The support assemblies are coupled to the beams. The frame members extend downwardly from the support assemblies and are coupled to the shelf. The support assemblies' spherical coupling allows for the frame members to be disposed at an adjustable angle relative to the shelf. Thus, regardless of the spacing of the beams, the support assemblies are directly coupled to the beams.

### BRIEF DESCRIPTION OF THE DRAWINGS

A full understanding of the invention can be gained from the following description of the preferred embodiments when read in conjunction with the accompanying drawings in which:

FIG. 1 is an isometric view of a storage assembly coupled to beams.

FIG. 2 is an exploded detail isometric view of a support assembly.

FIG. 3 is an isometric view of another embodiment of the storage assembly coupled to both horizontal and vertical beams.

FIG. 4 is an isometric view of another embodiment of a storage assembly coupled to both horizontal and vertical beams.

FIG. 5 is an isometric view of another embodiment of the storage assembly including an extendable frame member.

FIG. 6 is an isometric view of a storage system coupled to beams.

FIG. 7 is an isometric view of a storage system.

FIG. 8 is a partially exploded isometric view of a support assembly.

FIG. 9 is a detail isometric view of a bracket member.

FIG. 10 is an isometric view of another embodiment of the storage system.

FIG. 11 is an isometric view of another embodiment of the storage system.

FIG. 12 is an isometric view of another embodiment of the storage system.

FIG. 13 is an isometric view of another embodiment of the storage system.

FIG. 14 is a detail isometric view of a hub.

FIG. 15 is a detail isometric view of an extension coupling.

FIG. 16 is a detail isometric view of a spherical lug.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g. an axle first end being coupled to a first wheel means that the specific portion of the first element is disposed closer to the second element than the other portions thereof.

As used herein, the statement that two or more parts or components “engage” one another shall mean that the parts exert a force against one another either directly or through one or more intermediate parts or components.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such the components of a “coupling assembly” may not be described at the same time in the following description.

As used herein, a “coupling” or “or coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening are made from a deformable or compressible material, the opening may even be slightly smaller than the component being inserted into the opening. This definition is further modified if the two components are said to “substantially correspond.” “Substantially correspond” means that the size of the opening is very close to the size of the element inserted therein; that is, not so close as to cause substantial friction, as with a snug fit, but with more contact and friction than a “corresponding fit,” i.e., a “slightly larger” fit.

As used herein, a “pivot coupling” or “pivotal coupling” allows for rotation between two coupled elements in more than one plane. For example, a joystick pivotally coupled to a base can move forward/backward, left/right, or a combination thereof. A “pivot coupling” may also allow for rotation about three axes.

As used herein, a “rotational coupling” allows for rotation in one plane. For example, a traditional light switch that is limited to an up/down movement is a rotational coupling. In an exemplary embodiment, a rotational coupling includes three components; a first generally circular opening in a first element, a second generally circular opening in a second element, and a generally circular pin corresponding to the openings. When assembled, the openings on the two elements are aligned and the pin inserted therethrough. In such an embodiment, and in the description below, it is understood that the pin is considered to be part of the first rotational coupling. In another exemplary embodiment, one element includes a generally circular opening and the other element includes a generally circular lug corresponding to the opening. These two examples are not limiting and other configurations of rotational couplings may be used.

As used herein, an “extendable member” is a member including multiple members coupled so as to provide a variable length. This may be accomplished in any manner such as, but not limited to, telescoping members, members coupled to a medial threaded rod, or members coupled to an extension coupling.

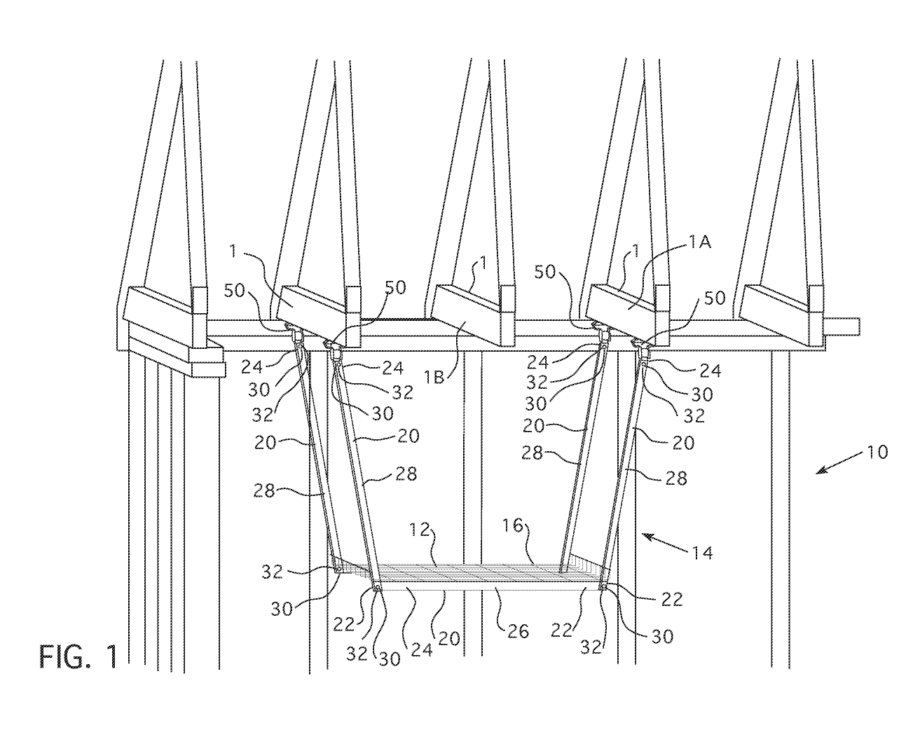

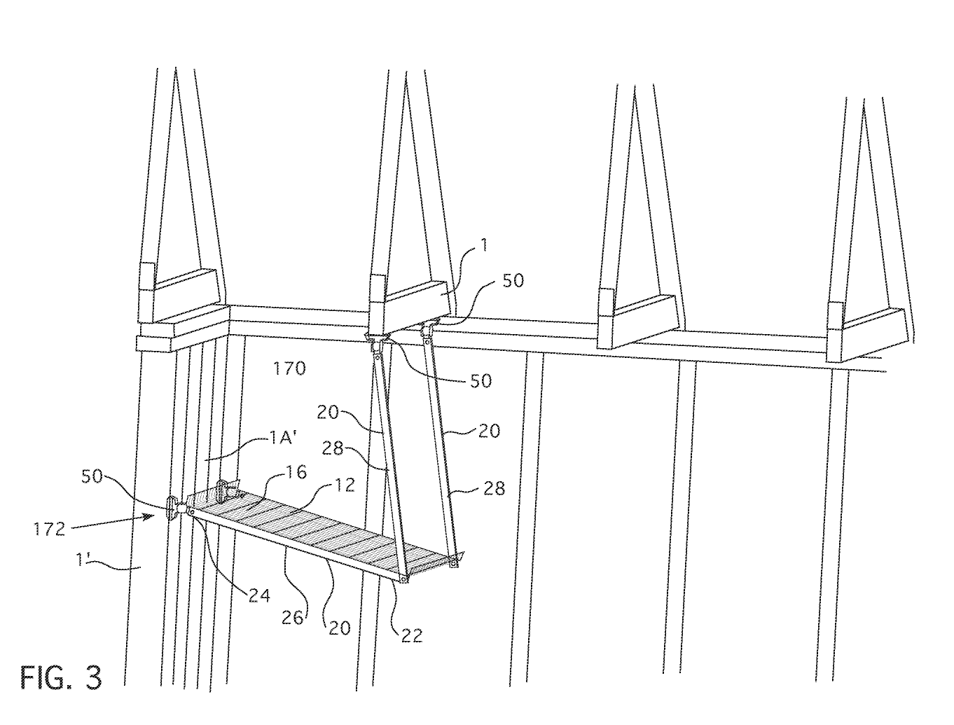

As shown in FIG. 1, a storage system 10 is structured to be coupled to a number of beams 1. The beams 1 may be generally horizontal beams 1, as shown in FIG. 1, or may be generally vertical beams 1 (also called studs) as shown in FIG. 3. It is understood that the beams 1 may be disposed behind a covering, such as, but not limited to plaster, sheetrock, or drywall panels. If there is a covering, it is understood that the second mounting coupling component 76, discussed below, extend through the covering and are coupled to the beams 1. It is understood that beams are generally spaced by a standard distance; in an exemplary embodiment, not shown, the standard spacing is about 16 inches or about 24 inches apart. As shown in FIG. 1, the beams 1 are disposed about 18 inches apart from each other, which is not a standard spacing.

The storage system 10 includes a shelf member 12, a frame assembly 14, and a number of support assemblies 50. In an exemplary embodiment, the shelf member 12 is generally planar and is shown as a grate 16. The shelf member 12 has a lateral width that is a multiple of a standard beam spacing. In the exemplary embodiment, shown in FIG. 1, the shelf member 12 has a lateral width of about 32 inches.

The frame assembly 14 includes a number of elongated frame members 20. As shown, a number of frame members 20 are shelf support frame members 26 that extend generally horizontally and are coupled, directly coupled or fixed to the shelf member 12. The frame members 20 that support the shelf member 12 are hereinafter identified as “shelf support frame members 26.” The other frame members 20 extend, very generally, vertically and support the weight of the shelf member 12, as well as any objects disposed thereon. In this configuration, the generally vertical frame members 20 are in tension and hereinafter are identified as “tension frame members 28.” As shown, the tension frame members 28 extend through the grate 16 and the grate 16 is disposed upon shelf support frame members 26. It is noted that descriptions applicable to both shelf support frame members 26 and tension frame members 28 shall refer to frame members 20.

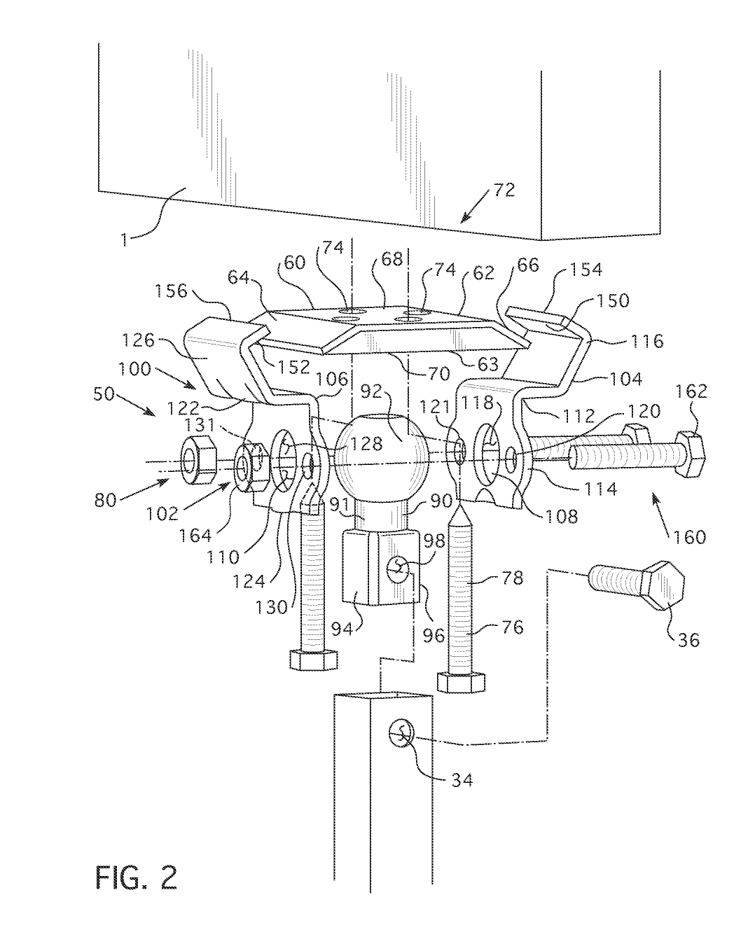

The frame members 20 each include a first end 22 and a second end 24. The frame members 20 may have any cross-sectional shape and, in an exemplary embodiment as shown, have a hollow square cross-sectional shape. The frame members 20 include a coupling 30 at each of the frame member first and second ends 22, 24. In an exemplary embodiment, the frame member coupling 30 is a rotational coupling 32. Further, in an exemplary embodiment, shown in FIG. 2, the frame member coupling 30 is a “first” rotational coupling and includes a generally circular opening 34 and a bolt 36 with a generally circular shaft. It is understood that a nut (not shown) is coupled to bolt 36.

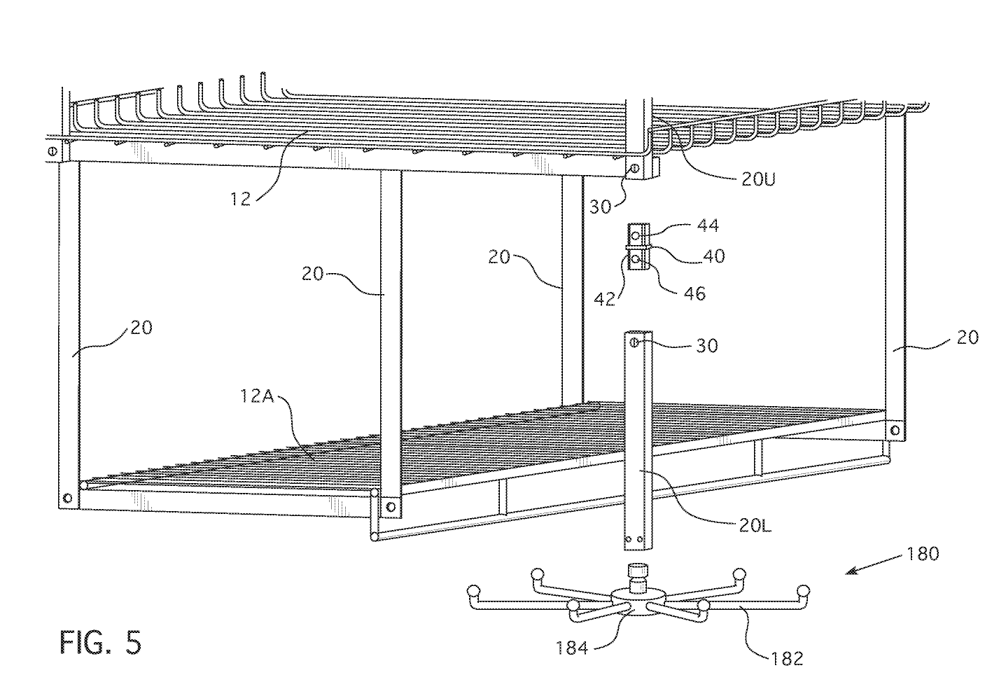

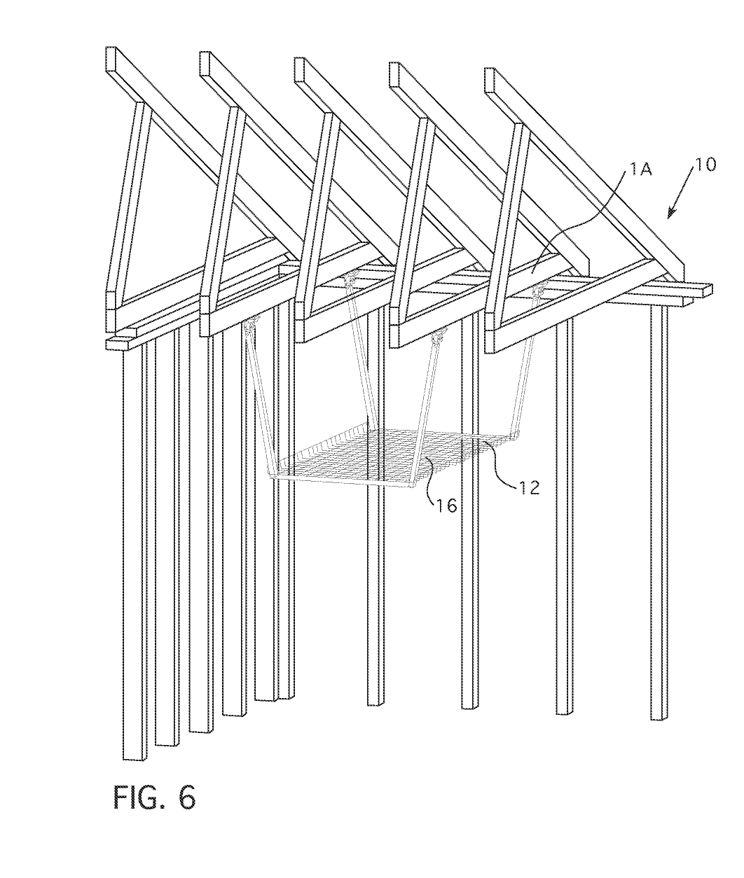

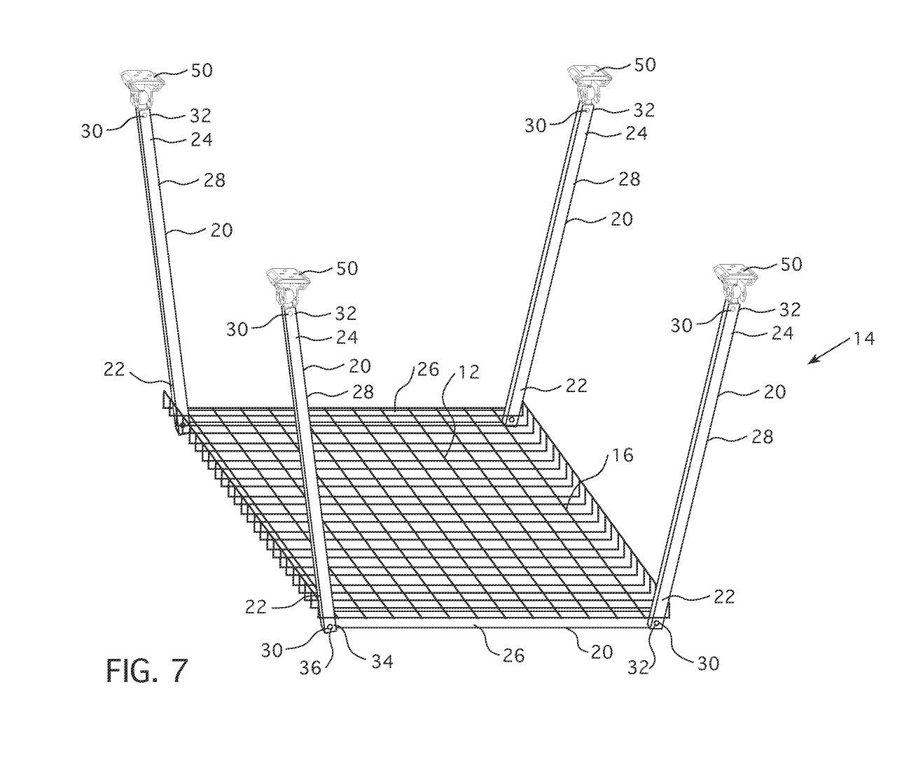

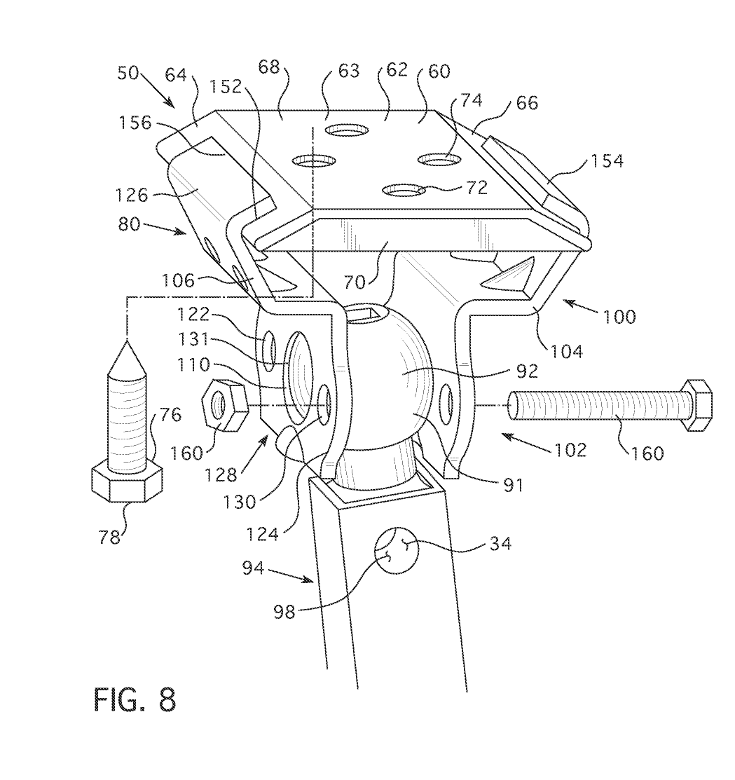

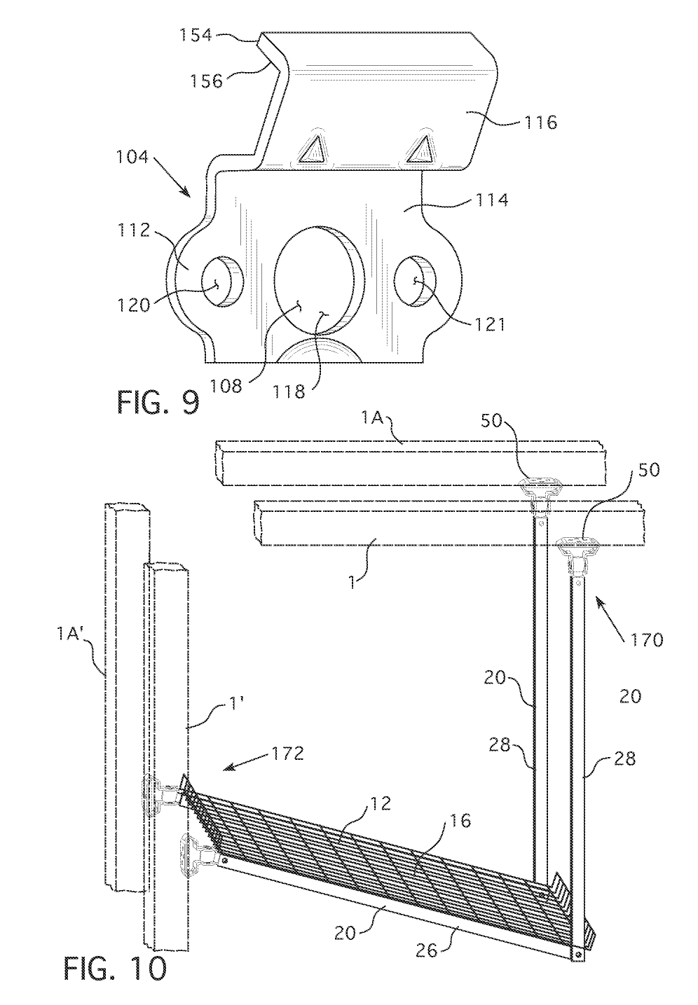

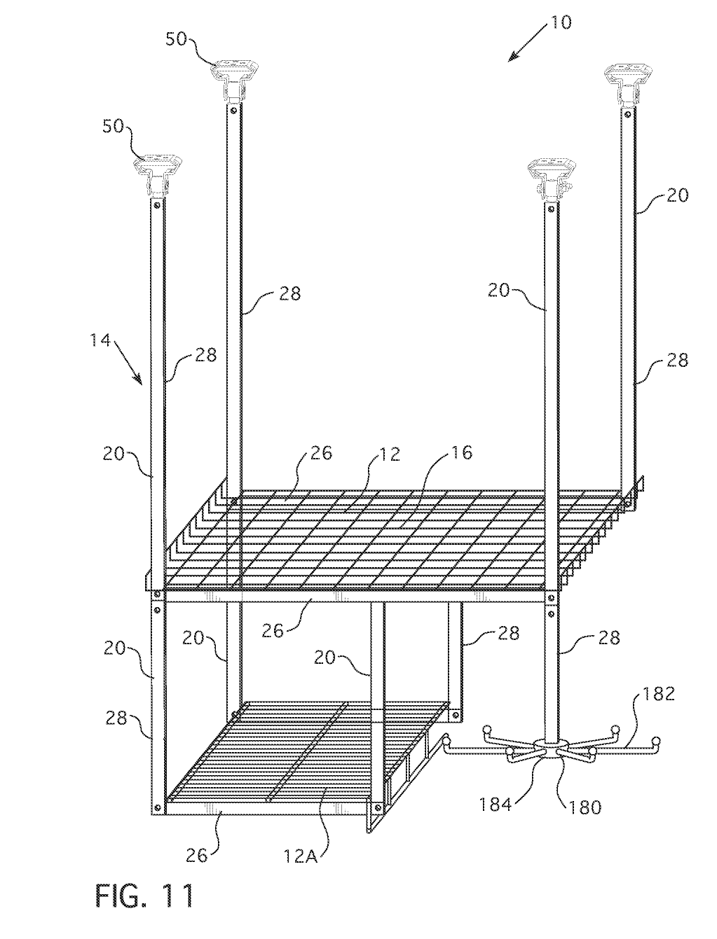

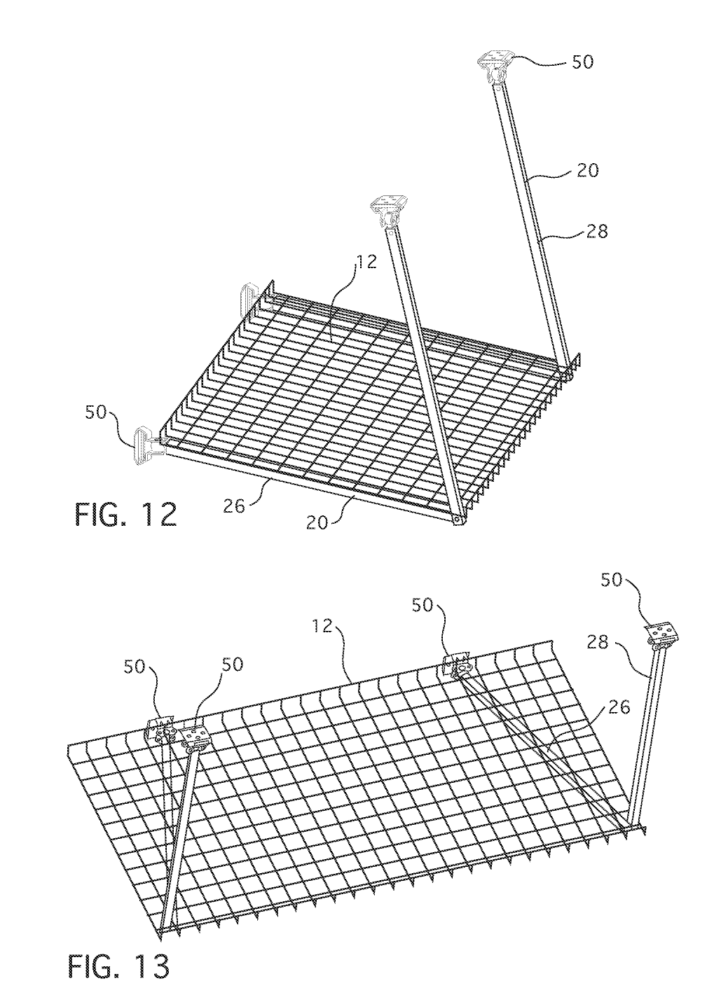

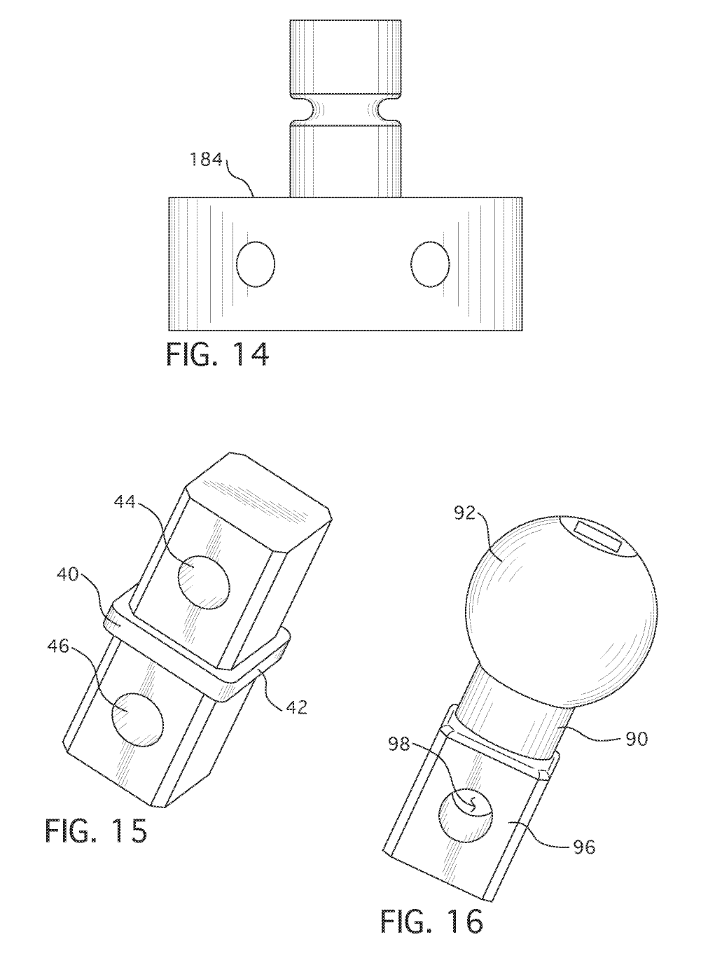

In an exemplary embodiment, at least one of the frame members 20 is an extendable member. That is, as shown in FIG. 5, the number of frame members 20 include an upper frame member 20U and a lower frame member 20L. In between the upper and lower frame members 20U, 20L is an extension coupling 40. The extension coupling 40 includes a body 42 structured to be coupled to both the upper and lower frame members 20U, 20L. As shown, the upper and lower frame members 20U, 20L have a hollow square cross-sectional area. The extension coupling 40 also has a square cross-sectional area; the extension coupling 40 square cross-sectional area is smaller than the upper and lower frame members 20U, 20L. Thus, the extension coupling 40 fits within the upper and lower frame members 20U, 20L. The extension coupling 40 also includes at least two couplings 44, 46 positioned to be coupled to the frame member couplings 30 on the upper and lower frame members 20U, 20L. Thus, the extension coupling 40 is used to couple the upper frame member 20U to the lower frame member 20L, thereby effectively increasing the length of the upper frame member 20U. It is noted that the lower frame member 20L has a length that is different than the upper frame member 20U. Thus, frame members 20 of different lengths may be coupled so as to create a frame member assembly of a desired length.

The support assemblies 50 are substantially similar and only one will be described. As shown in FIG. 2, the support assembly 50 includes a mounting 60 and a socket assembly 80. The mounting 60 includes a body 62 defining opposing engagement surfaces 64, 66, an inner surface 68 and an outer surface 70. In an exemplary embodiment, the mounting body 62 is a generally planar body 63. In one embodiment, not shown, the mounting engagement surfaces 64, 66 are generally parallel to each other. In an exemplary embodiment, however, the mounting engagement surfaces 64, 66 are angled relative to each other. As shown in FIG. 2, the mounting engagement surfaces 64, 66 are, in an exemplary embodiment, tapered from the mounting outer surface 70 to the mounting inner surface 68. That is, the mounting outer surface 70 has a greater cross-sectional area than the mounting inner surface 68. The angled mounting body engagement surfaces 64, 66, i.e. the mounting body engagement surfaces 64, 66 that are not generally vertical, are hereinafter identified as the mounting body first engagement surface 64 and mounting body second engagement surface 66. The mounting body 62 further includes a first mounting coupling component 72. In an exemplary embodiment, the first mounting coupling component 72 includes is a number of passages 74 through which a second mounting coupling component 76 may pass. As shown, the second mounting coupling component 76 is, in an exemplary embodiment, a number of wood screws 78. It is further noted that the mounting body number of passages 74 are disposed in an X pattern with each mounting body number of passages 74 disposed at a medial location relative to an edge of the mounting body 62. It is noted that in this pattern, the mounting body 62 may be coupled to beam 1 in a number of orientations. That is, for example, the longitudinal axis of the mounting body 62 does not have to align with the longitudinal axis of the beam 1.

The socket assembly 80 includes a spherical lug 90 and a bracket assembly 100. The spherical lug 90 includes a body 91 having a generally spherical portion 92 and a coupling component 94. In one embodiment, not shown, the spherical lug coupling component 94 is a threaded bore extending into the spherical lug spherical portion 92. In an exemplary embodiment, shown in FIG. 2, the spherical lug coupling component 94 is a radial extension 96, i.e. an elongated extension that extends radially from the spherical lug spherical portion 92, defining a perpendicular passage 98 having a generally circular cross-section. That is, the perpendicular passage 98 extends generally perpendicular to the longitudinal axis of the radial extension 96. The perpendicular passage 98, in an exemplary embodiment, is a “second” rotational coupling 99.

The bracket assembly 100 defines a spherical socket 102 sized to correspond to the spherical lug spherical portion 92. As shown, in an exemplary embodiment, the spherical socket 102 includes two circular openings 118, 128, discussed below, that are maintained in a spaced relation to each other. In an exemplary embodiment, the bracket assembly 100 includes a first bracket member 104 and a second bracket member 106. The first bracket member 104 and second bracket member 106 are, in an exemplary embodiment, mirror images of each other. The first bracket member 104 includes a first spherical coupling 108. The second bracket member 106 includes a second spherical coupling 110. In an exemplary embodiment, not shown, the first and second spherical couplings 108, 110 are convex domes. In an exemplary embodiment, shown in FIG. 2, the first and second spherical couplings 108, 110 are generally circular openings 118.

That is, the first bracket member 104 includes a body 112 having a planar member 114 and a clamping member 116. The first bracket member planar member 114 includes a circular opening 118 that is the first spherical coupling 108. The first bracket member planar member 114 also includes two passages 120, 121 that are disposed on opposing sides of the first spherical coupling 108. Similarly, the second bracket member 106 includes a body 122 having a planar member 124 and a clamping member 126. The second bracket member planar member 124 includes a circular opening 128 that is the second spherical coupling 110. The second bracket member planar member 124 also includes two passages 130, 131 that are disposed on opposing sides of the second spherical coupling 110.

The first and second bracket member clamping members 116, 126 each define an engagement surface 150, 152. In an exemplary embodiment, not shown, the first and second bracket member clamping members 116, 126 are planar extensions of the first and second bracket member planar members 114, 124. In an exemplary embodiment, shown in FIG. 2, the first and second bracket member clamping members 116, 126 are generally convex members having generally planar distal ends 154, 156. In this configuration, the first and second bracket member clamping members 116, 126 are structured to engage the mounting body first engagement surface 64 and mounting body second engagement surface 66, respectively.

As shown, the first and second bracket members 104, 106 are positioned adjacent each other with the generally convex first and second bracket member clamping members 116, 126 facing each other. A spherical lug spherical portion 92 is disposed between the first and second bracket members 104, 106 and, more specifically, disposed within the first and second spherical couplings 108, 110. A number of bracket member couplings 160, such as, but not limited to bolts and nuts 162, 164 are passed through first and second bracket member body passages 120, 121 and 130, 131. Further, the first and second bracket member clamping member engagement surface 150, 152 are disposed over the mounting body first engagement surface 64 and mounting body second engagement surface 66, respectively.

In this configuration, the first and second bracket members 104, 106 are movably coupled to each other and structured to move between a spaced, first configuration, wherein an associated spherical lug spherical portion 92, i.e. the spherical lug spherical portion 92 of the spherical lug 90 disposed between with the first and second bracket members 104, 106, is movably, and more specifically pivotally, coupled to the bracket assembly 100 and the first bracket member clamping members engagement surface 150 loosely engages the mounting body first engagement surface 64 and the second bracket member clamping members engagement surface 152 loosely engages the mounting body second engagement surface 66, and, a contracted, second configuration, wherein the associated spherical lug spherical portion 92 is snuggly coupled to the bracket assembly 100, the first bracket member engagement surface 150 snuggly engages the mounting body first engagement surface 64 and the second bracket member engagement surface 152 snuggly engages the mounting body second engagement surface 66. That is, generally, in the first configuration, the bracket member couplings 160 are loose and the spherical lug spherical portion 92 moves generally freely and upon application of a light force. In the second configuration, the bracket member couplings 160 are tight and the spherical lug spherical portion 92 is held snuggly, but may be moved upon application of a greater force.

The components of the storage system 10 are assembled in various configurations, discussed below, so as to support the shelf member 12. Generally, each support assembly 50 is coupled to a beam 1. At least one support assembly 50 is coupled to a beam 1A, or as discussed below beam 1′, that is spaced from the other support assemblies 50. That is, the support assemblies 50 are not all coupled to the same beam 1. Further, one frame member 20 extends between one support assembly 50 and the shelf member 12 or the shelf support frame members 26. It is understood that the one frame member 20 that extends between one support assembly 50 and the shelf member 12 is the tension member “associated” with that support assembly 50. It is further noted that the components of one support assembly 50 are “associated” with each other.

In an exemplary embodiment, as shown in FIG. 1, the storage system 10 is assembled so as to support the shelf member 12 from overhead beams 1, 1A. As noted above, the shelf 12 has a width of about 32 inches and the beams 1, 1A, which have one beam 1B disposed therebetween, are spaced about 36 inches apart. That is, the beams 1, 1A, 1B are not spaced as a multiple of a standard spacing of 16 or 24 inches. The storage system 10, as shown, includes four support assemblies 50 coupled, two each, to the two spaced beams 1, 1A. Initially, each mounting 60 is coupled, directly coupled or fixed, to a beam 1, 1A by the second mounting coupling component 76, in an exemplary embodiment, wood screws 78. Each bracket assembly 100, which is initially in the first position, is coupled to the associated mounting 60 by positioning the first and second bracket member clamping members 116, 126 over the mounting body first engagement surface 64 and mounting body second engagement surface 66, respectively.

Each tension frame member 28 is passed through grate 16 and grate 16 rests upon the shelf support frame member 26. Each tension frame member 28 is then coupled to an associated support assembly 50 by the rotational coupling 30 disposed at the tension frame member second end 24. That is, in an exemplary embodiment, a pin is passed through the tension frame member second end 24 and the associated spherical lug coupling component 94. Each tension frame member 28 is then coupled to a shelf support frame member 26 by the rotational coupling 30 disposed at the tension frame member first end 22. It is noted that the tension frame members 28, as shown, are not generally perpendicular to the plane of the shelf member 12 and has an “offset,” as described below. It is noted that the rotational couplings 30 disposed at the tension frame member first end 22 allows for the tension frame members 28 to be coupled to the shelf member 12, but not be disposed generally perpendicular to the plane of the shelf member 12. That is, the rotational couplings 30 disposed at the tension frame member first end 22 allows for the tension frame members 28 to rotate relative to the plane of the shelf member 12. To accomplish this, the axis of rotation for the rotational couplings 30 disposed at the tension frame member first end 22 extends generally parallel to the beams 1, 1A as shown. It is noted that if beams 1, 1A are at a standard spacing (not shown), the storage system 10 can still be used and that the tension frame members 28 would be generally perpendicular to the plane of the shelf member 12 and there would not be a substantial “offset.”

As noted above, the shelf member 12 has a lateral width that is a multiple of the standard beam spacing. In FIG. 1, the shelf member 12 has a lateral width that is twice as wide as the standard beam spacing shown. The beams 1, 1A, however, are not spaced by a standard spacing and, as shown, are spaced slightly further apart than the standard beam spacing. In this configuration, the tension frame member 28 extend at an angle relative to plane of the shelf member 12 and generally outwardly relative to the shelf member 12. Thus, as used herein, “generally vertical” frame members 20 include frame members 20 disposed at between about 0 degrees to 45 degrees from vertical.

In one exemplary embodiment, a tension frame member 28 is offset by between about 1.0 inches to about 16.0 inches. That is, as used herein, the “offset” is the horizontal distance between a vertical line passing through the tension frame member first end 22 and a vertical line passing through the tension frame member second end 24. In another exemplary embodiment, a tension frame member 28 is offset by between about 2.0 inches to about 10.0 inches. In another exemplary embodiment, a tension frame member 28 is offset by between about 3.0 inches to about 8.0 inches. In another exemplary embodiment, a tension frame member 28 is offset by about 4.0 inches.

In another exemplary embodiment, shown in FIG. 3, the beams 1 include vertical beams 1′, 1A′. That is, there is a first horizontal beam 1, a first vertical beam 1′ and a second vertical beam 1A′. As before, the spacing between the beams 1′, 1A′ is not a standard spacing of 16 or 24 inches. Further, the number of bracket assemblies 50 includes a first set of bracket assemblies 170 and a second set of bracket assemblies 172, hereinafter the “first set 170” and the “second set 172.” Further, for the sake of this description, the shelf support frame member second end 24 will be the end of the shelf support frame member 26 disposed adjacent to the vertical beams 1′, 1A′.

The bracket assemblies 100 in the first set 170 are coupled to the horizontal beam 1 and to the shelf member 12 in a manner substantially similar to the embodiment described above. The bracket assemblies 50 in the second set 172 are coupled to the vertical beams 1′, 1A′. That is, each mounting 60 from a bracket assembly 100 in the second set 172 is coupled, directly coupled or fixed, to a beam 1′, 1A′ by the second mounting coupling component 76, in an exemplary embodiment, wood screws 78. Each bracket assembly 100 in the second set 172, which are initially in the first position, is coupled to the associated mounting 60 by positioning the first and second bracket member clamping members 116, 126 over the mounting body first engagement surface 64 and mounting body second engagement surface 66, respectively.

Each shelf support frame member 26 is then coupled to an associated support assembly 50 in the second set 172 by the rotational coupling 30 disposed at the shelf support frame member second end 24. That is, in an exemplary embodiment, a bolt 36 is passed through the shelf support frame member second end 24 and the associated spherical lug coupling component 94. The self-member 12 is then disposed on the shelf support frame members 26. It is noted that the bracket assemblies 100 in the second set 172 may be positioned on the vertical beams 1′, 1A′ at a location above the tension frame member first end 22, thereby causing shelf member 12 to be tilted. In this configuration, shelf member 12 can be used to display goods and other objects. In another embodiment, not shown, all frame members 20 are coupled to vertical beams 1′, 1A′.

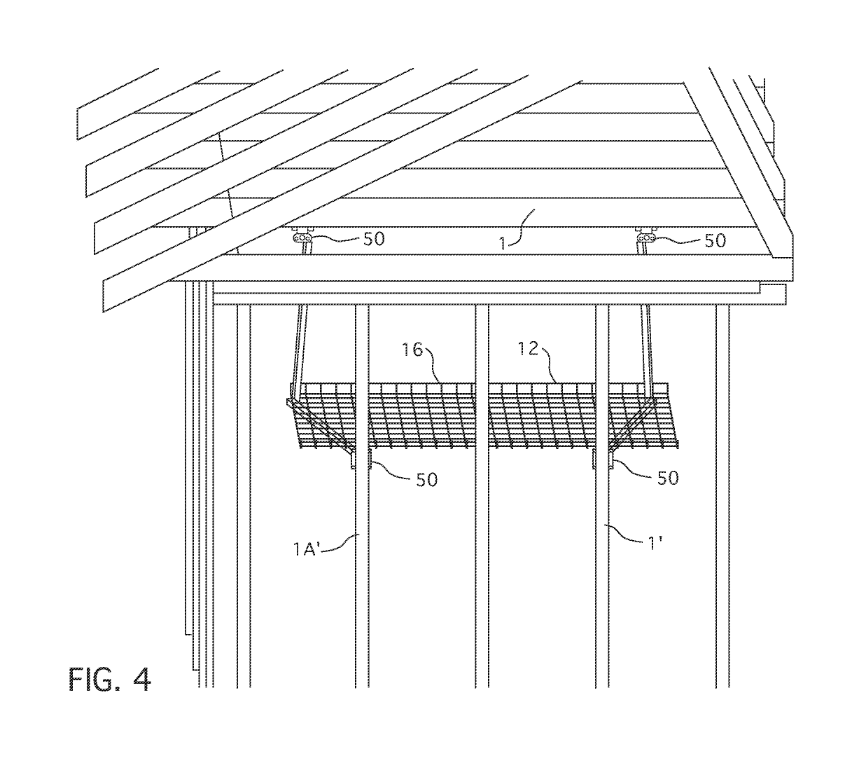

As shown in FIG. 4, the support assemblies 50, and more specifically the pivotal coupling between spherical lug 90 and bracket assembly 100, allows for the frame members 20 to be askew relative to the vertical beams 1′, 1A′. That is, as shown, the tension frame members 28 are spaced so as to be disposed at a greater distance than vertical beams 1′, 1A′. The spherical lug 90 for each support assembly 50 associated with a tension frame members 28 rotates about a generally vertical axis so as to allow the rotational coupling at each tension member second end 24 to be askew. That is, the axis for each rotational coupling at each tension member second end 24 is not parallel or perpendicular to beam 1. Similarly, the spherical lug 90 for each support assembly 50 associated with a shelf support frame member 26 pivots, as described above, so as to allow each shelf support frame member 26 to extend at an angle relative to the vertical beams 1′, 1A′. In this configuration, the frame member first ends 22 of the tension frame members 28 and the shelf support frame members 26 are aligned so that a bolt 36 may pass through the rotational coupling disposed thereat.

As shown in FIG. 5, the storage system 10 may include additional frame members 20 and shelf members 12A that can be assembled as an additional shelf 12A suspended from the upper shelf member 12. Further, other frame elements, such as, but not limited to, a radial support assembly 180 having a plurality of radial arms 182 extending generally horizontally from a hub 184 can be coupled the frame members 20.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A support assembly comprising:
a mounting;
a socket assembly including a spherical lug and a bracket assembly;
said bracket assembly defining a spherical socket;
said bracket assembly coupled to said mounting;
said spherical lug including a body with a generally spherical portion and a coupling component; and
said spherical lug pivotally coupled to said bracket assembly spherical socket.

2. The support assembly of claim 1 wherein:
said socket assembly includes a first bracket member and a second bracket member;
said first bracket member including a first spherical coupling;
said second bracket member including a second spherical coupling; and
said spherical lug spherical portion pivotally coupled to said first spherical coupling and said second spherical coupling.

3. The support assembly of claim 2 wherein said first and second bracket members are movably coupled to each other and structured to move between a spaced, first configuration, wherein said spherical lug spherical portion is movably coupled to said socket assembly, and a contracted, second configuration, wherein said spherical lug spherical portion is snuggly coupled to said socket assembly.

4. The support assembly of claim 2 wherein:
said first bracket member and a second bracket member each include a planar member and a clamping member;
each said bracket member planar member defining a generally circular opening, wherein each said circular opening is a spherical coupling; and
each said bracket member clamping member defining an engagement surface.

5. The support assembly of claim 4 wherein:
said mounting includes a generally planar body with a first engagement surface and a second engagement surface, said first and engagement surfaces disposed on opposing sides of said planar body;
said first bracket member engagement surface engaging said mounting body first engagement surface;
said second bracket member engagement surface engaging said mounting body second engagement surface; and
wherein said first and second bracket members are movably coupled to each other and structured to move between a spaced, first configuration, wherein said spherical lug spherical portion is movably coupled to said socket assembly, said first bracket member engagement surface loosely engages said mounting body first engagement surface, and said second bracket member engagement surface loosely engages said mounting body second engagement surface, and a contracted, second configuration, wherein said spherical lug spherical portion is snuggly coupled to said socket assembly, said first bracket member engagement surface snuggly engages said mounting body first engagement surface, and said second bracket member engagement surface snuggly engages said mounting body second engagement surface.

6. The support assembly of claim 5 wherein:
said first bracket member planar member includes a first passage and a second passage;
said second bracket member planar member includes a first passage and a second passage;
a bracket member coupling coupled to said first bracket member planar member first and second passages; and
a bracket member coupling coupled to said second bracket member planar member first and second passages.

7. A storage system, said storage system structured to be coupled to a number of beams, said storage system comprising:
a shelf member;
a frame assembly including a number of frame members, each frame member including a first end and a second end;
said number of frame members including tension frame members;
each said tension frame member first end couple to said shelf member;
a number of support assemblies, each support assembly coupled to one said beam and to one associated tension frame member at the associated tension frame member second end;
each said support assembly including a mounting and a socket assembly;
each said socket assembly including a spherical lug and a bracket assembly;
each said bracket assembly defining a spherical socket;
each said bracket assembly coupled to an associated mounting;
each spherical lug including a spherical portion and a coupling component; and
each said spherical lug pivotally coupled to an associated bracket assembly.

8. The storage system of claim 7 wherein:
each said bracket assembly includes a first bracket member and a second bracket member;
each said first bracket member including a first spherical coupling;
each said second bracket member including a second spherical coupling; and
each said spherical lug spherical portion pivotally coupled to an associated bracket assembly's first spherical coupling and said second spherical coupling.

9. The storage system of claim 8 wherein said each bracket assembly first and second bracket members movably are coupled to each other and structured to move between a spaced, first configuration, wherein an associated spherical lug spherical portion is movably coupled to said bracket assembly, and a contracted, second configuration, wherein the associated spherical lug spherical portion is snuggly coupled to said bracket assembly.

10. The storage system of claim 8 wherein:
each said first bracket member and each said second bracket member include a planar member and a clamping member;
each said bracket member planar member defining a generally circular opening, wherein each said circular opening is a spherical coupling; and
each said bracket member clamping member defining an engagement surface.

11. The storage system of claim 10 wherein:
each said mounting includes a generally planar body with a first engagement surface and a second engagement surface, said first and second engagement surfaces disposed on opposing sides of said planar body;
each said first bracket member engagement surface structured to engage an associated mounting body first engagement surface;
said second bracket member engagement surface structured to engage an associated mounting body second engagement surface; and
wherein each pair of associated first and second bracket members are movably coupled to each other and structured to move between a spaced, first configuration, wherein an associated spherical lug spherical portion is movably coupled to said bracket assembly, said first bracket member engagement surface loosely engages said mounting body first engagement surface, and said second bracket member engagement surface loosely engages said mounting body second engagement surface, and a contracted, second configuration, wherein the associated spherical lug spherical portion is snuggly coupled to said bracket assembly, said first bracket member engagement surface snuggly engages said mounting body first engagement surface, and said second bracket member engagement surface snuggly engages said mounting body second engagement surface.

12. The storage system of claim 11 wherein:
said first bracket member planar member includes a first passage and a second passage;
said second bracket member planar member includes a first passage and a second passage;
a bracket member coupling coupled to said first bracket member planar member first and second passages; and
a bracket member coupling coupled to said second bracket member planar member first and second passages.

13. The storage system of claim 11 wherein:
each said mounting first engagement surface is not a generally vertical surface; and
each said mounting second engagement surface is not a generally vertical surface.

14. The storage system of claim 11 wherein:
each said spherical lug coupling component is a rotatable coupling;
each said frame member first end includes a rotatable coupling;
each said frame member second end includes a rotatable coupling;
each said tension frame member first end rotatable coupling rotatably coupled to a spherical lug rotatable coupling; and
each said tension frame member second end rotatable coupling rotatably coupled to a shelf member rotatable coupling.

15. The storage system of claim 14 wherein said number of frame members includes four, each said tension frame member extending generally vertically.

16. The storage system of claim 14 wherein said beams include vertically extending beams and horizontally extending beams, and wherein:
said number of frame members includes two tension frame members and two shelf support members;
each said tension frame member extending generally vertically;
each said shelf support member extending generally horizontally;
said number of bracket assemblies includes a first set of bracket assemblies and a second set of bracket assemblies;
each bracket assembly in said first set of bracket assemblies is coupled to a horizontally extending beam and a frame member; and
each bracket assembly in said second set of bracket assemblies is coupled to a vertically extending beam and a frame member.

17. The storage system of claim 7 wherein at least one frame member is an extendable member.
